(19) United States
(12) Patent Application Publication
(10) Pub. No.: US 2018/0151128 A1
(43) Pub. Date: May 31, 2018

(54) Driving circuit and operating method thereof

(71) Applicant: Raydium Semiconductor Corporation, Hsinchu (TW)

(72) Inventors: Yu-Chao CHANG, Zhubei City (TW); Tsung-Yao PAI, Taichung City (TW); Jun-Ren SHIH, Hsinchu City (TW); Shang-Ping TANG, Zhubei City (TW)

(21) Appl. No.: 15/821,873

(22) Filed: Nov. 24, 2017

Related U.S. Application Data
(60) Provisional application No. 62/426,333, filed on Nov. 25, 2016.

(51) Int. Cl. G09G 3/3275; G09G 3/3266

(52) U.S. Cl. CPC G09G 3/3275; G09G 2360/12; G09G 3/3266

(57) ABSTRACT

A driving circuit and operating method thereof are disclosed. The driving circuit is coupled to a display panel. The driving circuit includes a memory. The method includes: (a) the driving circuit receives an image data including N frames, N is a positive integer; (b) during a first period, writing a first frame of image data into the memory along a first direction; and (c) during a second period, reading the first frame from the memory along a second direction and outputting it to the display panel and then writing a second frame of image data into the memory along the second direction. Wherein, since the second period is later then the first period and the second direction is opposite to the first direction, the first frame read from the memory in step (c) and the first frame written into the memory in step (b) are upside down each other.

### BACKGROUND OF THE INVENTION

### 1. Field of the Invention

This invention relates to a display, especially to a driving circuit applied in a display and an operating method thereof.

### 2. Description of the Prior Art

As shown in FIG. 1, the memory M (e.g., SRAM) is usually disposed in the conventional organic light-emitting diode (OLED) driver DR to be used as the frame buffer. After the original image data DAT0 is processed by the host HAP, the processed image data DAT will be transmitted to the OLED driver DR and then written into the memory M line-by-line and stored in the memory M. Afterward, the OLED driver DR will read the image data DAT from the memory M line-by-line and then transmit the image data DAT to the display panel PL. At this time, the gate driver GD (e.g., the gate on array (GOA) circuit) on the display panel PL will perform a forward scan S (e.g., from top to bottom) in order, so that the image data DAT transmitted by the OLED driver DR can be stored line-by-line in each row of pixels on the display panel PL and the display panel PL can normally display the image data DAT.

However, the display panel PL sometimes needs to be up-side down due to the system mechanism design; at this time, if the display panel PL wants to display the image data DAT in the forward direction, the image data DAT needs to be performed under V-flip process. For example, FIG. 2A shows that the display panel PL without being upside down (the first row of pixels G1˜the N-th row of pixels GN in order from top to bottom) displays the image data DAT without being performed under V-flip process; FIG. 2B shows that the display panel PL which is upside down (the N-th row of pixels GN˜the first row of pixels G1 in order from top to bottom) displays the image data DAT without being performed under V-flip process; FIG. 2C shows that the display panel PL which is upside down (the N-th row of pixels GN˜the first row of pixels G1 in order from top to bottom) displays the image data DAT which is performed under V-flip process, so that the display panel PL can display the image data DAT in the forward direction.

In order to make the image data DAT upside down, the following methods can be used:

(1) As shown in FIG. 3, the image data DAT is performed under V-flip process by the host HAP and then the upside down image data DAT′ is transmitted to the OLED driver DR; therefore, the OLED driver DR will transmit the upside down image data DAT′ to the display panel PL. However, since the image V-flip function is performed by the host HAP, in practical applications, the host HAP fails to be normally operated in the image V-flip mode due to compatibility issues, so that the host HAP fails to generate the upside down image data DAT′ to the OLED driver DR.

(2) As shown in FIG. 4, when the OLED driver DR transmits the image data DAT without being performed under V-flip process to the display panel PL, the gate driver GD on the display panel PL can change its scan direction on the display panel PL from the original forward scan (from top to bottom) to the reverse scan (from bottom to top), so that the display panel PL will display the upside down image data DAT′. However, since the gate driver GD on the display panel PL needs the reverse scanning function to do so, but the area of the display panel PL is limited due to the requirement of slim boarder, the gate driver GD on the display panel PL can only provide the forward scanning function or the reverse scanning function instead of providing both of them lack of flexibility in use.

(3) As shown in FIG. 5A and FIG. 5B, the OLED driver DR can write the image data DAT into the memory M and read the image data DAT from the memory M in opposite directions; that is to say, the direction that the OLED driver DR writes the image data DAT into the memory M is opposite to the direction that the OLED driver DR reads the image data DAT from the memory M, so that the OLED driver DR will transmit the upside down image data DAT′ to the display panel PL.

However, since the OLED driver DR writes the image data DAT into the memory M and reads the image data DAT from the memory M in frame-by-frame way, no matter the forward writing and reverse reading shown in FIG. 5A or the reverse writing and forward reading shown in FIG. 5B is used, as shown in FIG. 6A˜FIG. 6B and FIG. 7A˜FIG. 7B, during the same period (e.g., the second period TF2), since the time t2 of the reading action R1 for reading the previous frame of data from the memory M is earlier than the time t3 of the writing action W2 for writing the current frame of data into the memory M, and the writing direction of the writing action W2 (from top to bottom and from the first row of memory units L1 to the Y-th row of memory units LY) is opposite to the reading direction of the reading action R1 (from bottom to top and from the Y-th row of memory units LY to the first row of memory units L1). Therefore, a part of the previous frame of data stored in the memory M may be overwritten by the current frame of data written into the memory M by the OLED driver DR before being read by the OLED driver DR.

Once the image data DAT is dynamic picture, the above-mentioned condition may cause tearing effect occurred in the dynamic picture. Therefore, this method is suitable only when the image data DAT is static picture; as a result, the scope of its use and practicality will be severely limited.

### SUMMARY OF THE INVENTION

Therefore, the invention provides a driving circuit and an operating method thereof to solve the above-mentioned problems.

An embodiment of the invention is a driving circuit. In this embodiment, the driving circuit is coupled to a display panel. The driving circuit includes a receiving unit, a memory, a processing unit and an output unit. The receiving unit is used for receiving an image data comprising N frames, wherein N is a positive integer. The processing unit is coupled to the receiving unit and the memory respectively. During a first period, the processing unit writes a first frame of the image data into the memory along a first direction; during a second period, the processing unit reads the first frame from the memory along a second direction and then writes a second frame of the image data into the memory along the second direction. The output unit is coupled to the processing unit and the display panel respectively and used for outputting the first frame to the display panel. Wherein, since the second period is later then the first period and the second direction is opposite to the first direction, the first frame read from the memory by the processing unit and the first frame written into the memory by the processing unit are upside down each other.

In an embodiment, the display panel is an organic light-emitting diode (OLED) display panel.

In an embodiment, the first direction and the second direction are a direction from top to bottom and a direction from bottom to top respectively.

In an embodiment, during a second period, a time of the processing unit writing the second frame of the image data into the memory is later than a time of the processing unit reading the first frame from the memory, and a direction of the processing unit writing the second frame of the image data into the memory and a direction of the processing unit reading the first frame from the memory are both the second direction, so that when the second frame of the image data is written into the memory by the processing unit, the second frame of the image data does not overwrite the first frame of the image data which is not yet read by the processing unit to avoid a tearing effect.

In an embodiment, during a third period, the processing unit reads the second frame of the image data from the memory along the first direction and outputs the second frame of the image data to the display panel, and the third period is later than the second period.

In an embodiment, if no image is written into the memory by the processing unit during the third period, then during a fourth period, the processing unit reads the second frame of the image data from the memory along the first direction and outputs the second frame of the image data to the display panel, and the fourth period is later than the third period.

In an embodiment, during the third period, after the processing unit reads the second frame of the image data, the processing unit writes a third frame of the image data into the memory along the first direction; during a fourth period, the processing unit reads the third frame of the image data from the memory along the second direction and outputs the third frame of the image data to the display panel, and the fourth period is later than the third period.

Another embodiment of the invention is a driving circuit operating method. In this embodiment, the driving circuit operating method is used for operating a driving circuit coupled to a display panel. The driving circuit includes a memory. The driving circuit operating method includes steps of: (a) the driving circuit receiving an image data comprising N frames, wherein N is a positive integer; (b) during a first period, writing a first frame of the image data into the memory along a first direction; and (c) during a second period, reading the first frame from the memory along a second direction and outputting the first frame to the display panel and then writing a second frame of the image data into the memory along the second direction. Wherein, since the second period is later then the first period and the second direction is opposite to the first direction, the first frame read from the memory in step (c) and the first frame written into the memory in step (b) are upside down each other.

Compared to the prior art, the driving circuit and operating method thereof in the invention use a new memory writing and reading method to make the image data upside down cooperated with the upside down display panel and also effectively avoid the tearing effect caused by the conventional driving circuit performing V-flip process on the dynamic picture. Therefore, the driving circuit and operating method thereof in the invention can perform V-flip process on both the dynamic picture and the static picture without using the host and the gate driver (e.g., the GOA circuit) on the display panel to perform V-flip process on the image data, so that the scope of its use and practicality can be largely increased.

The advantage and spirit of the invention may be understood by the following detailed descriptions together with the appended drawings.

### BRIEF DESCRIPTION OF THE APPENDED DRAWINGS

FIG. 1 illustrates a schematic diagram of the conventional OLED driver in the prior art.

FIG. 2A illustrates that the display panel without being upside down displays the image data without being performed under V-flip process; FIG. 2B illustrates that the display panel which is upside down displays the image data without being performed under V-flip process; FIG. 2C illustrates that the display panel which is upside down displays the image data which is performed under V-flip process.

FIG. 3 illustrates a schematic diagram of the host performing V-flip process on the image data in the prior art.

FIG. 4 illustrates a schematic diagram of the gate driver performing reverse scan on the display panel in the prior art.

FIG. 5A and FIG. 5B illustrate schematic diagrams of the method of forward writing and reverse reading and the method of reverse writing and forward reading in the prior art respectively.

FIG. 6A and FIG. 6B illustrate schematic diagrams that the writing direction of writing the current frame of data is opposite to the reading direction of reading the previous frame of data during the same frame period in the prior art.

FIG. 7A and FIG. 7B illustrate timing diagrams that the writing direction of writing the current frame of data is opposite to the reading direction of reading the previous frame of data during the same frame period causing the tearing effect occurred in the dynamic picture in the prior art.

FIG. 8 illustrates a schematic diagram of the driving circuit in an embodiment of the invention.

FIG. 9A and FIG. 9B illustrate schematic diagrams that the writing direction of writing the current frame of data is the same with the reading direction of reading the previous frame of data during the same frame period in the invention.

FIG. 10A and FIG. 10B illustrate timing diagrams that the writing direction of writing the current frame of data is the same with the reading direction of reading the previous frame of data during the same frame period in the invention to avoid the tearing effect.

FIG. 11 illustrates a flowchart of the driving circuit operating method in another embodiment of the invention.

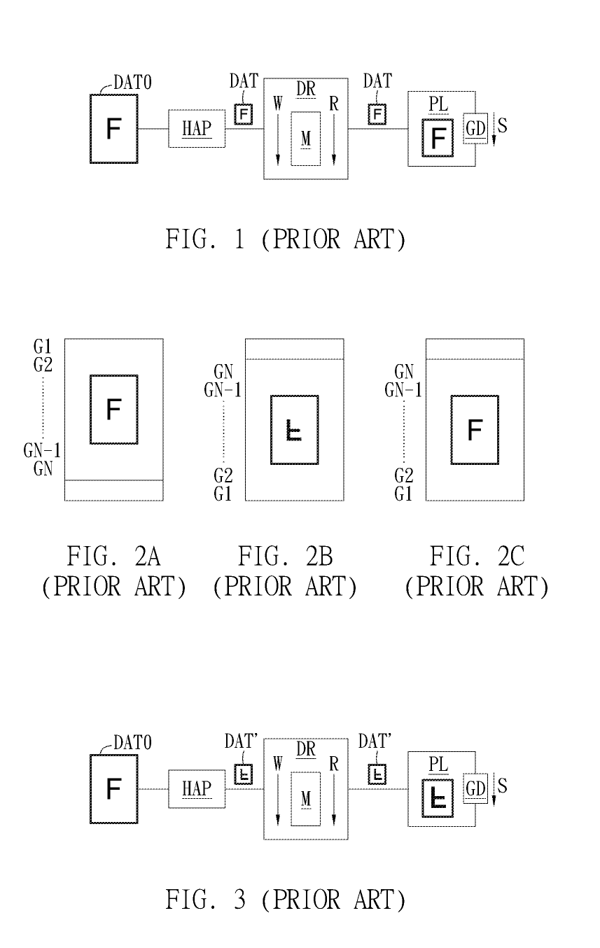

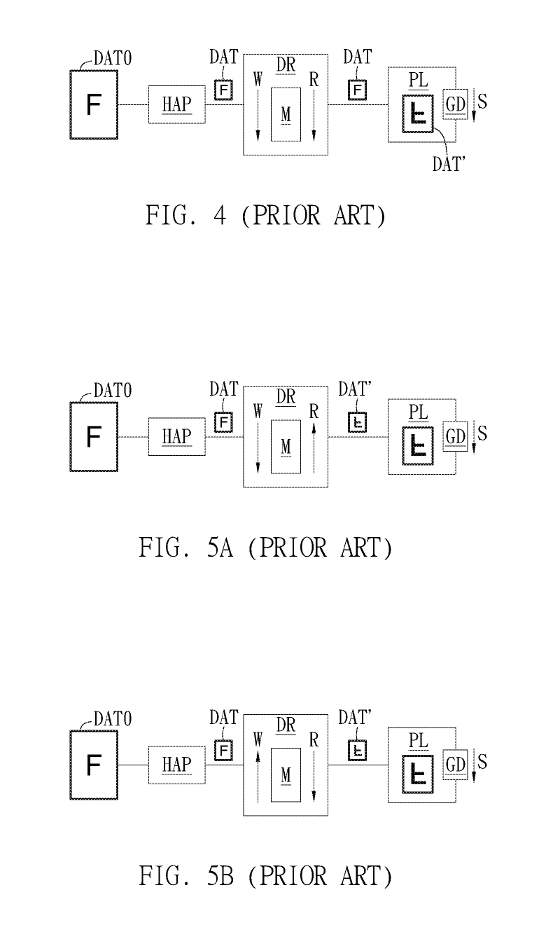

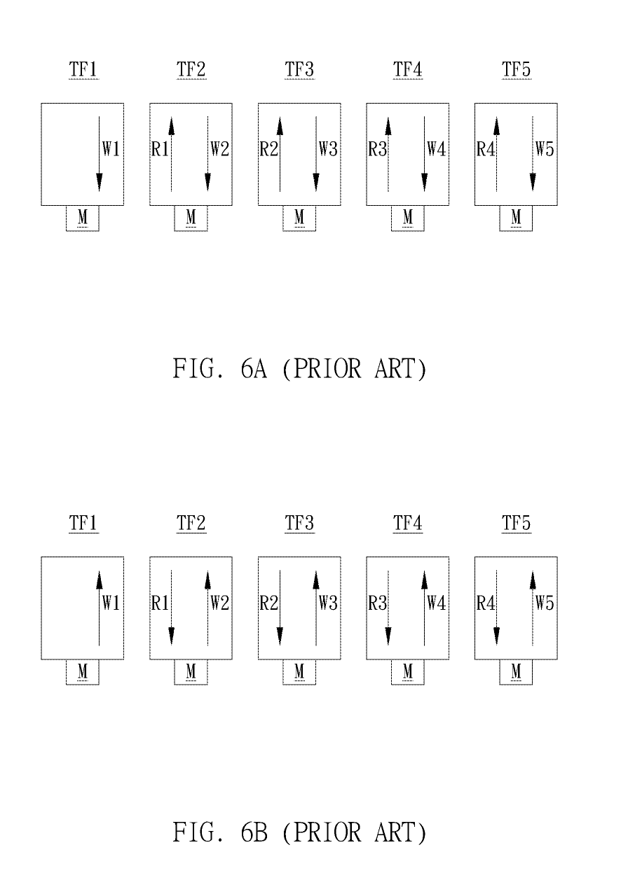

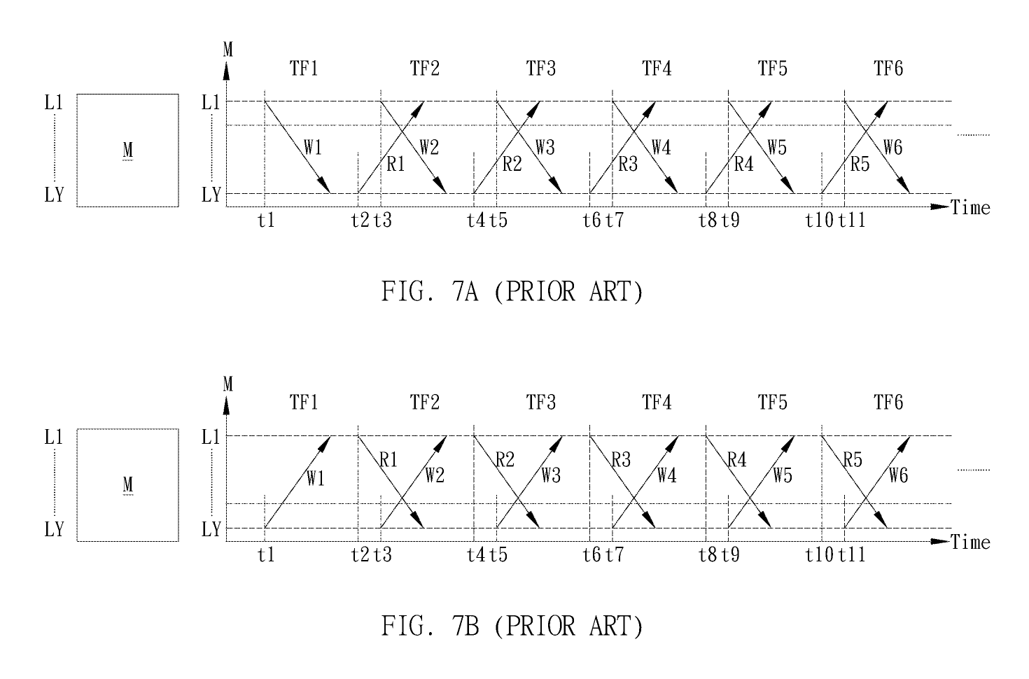

### DETAILED DESCRIPTION OF THE INVENTION

A preferred embodiment of the invention is a driving circuit. In this embodiment, the driving circuit is disposed in a display and coupled to an OLED display panel, but not limited to this.

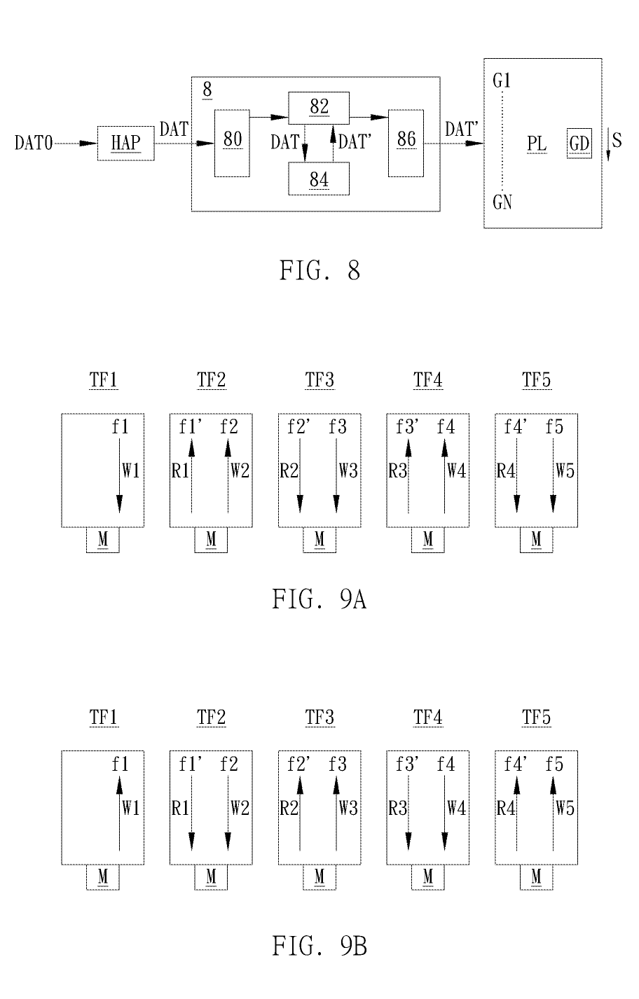

Please refer to FIG. 8. FIG. 8 illustrates a schematic diagram of the driving circuit used to drive the display panel in this embodiment. As shown in FIG. 8, the driving circuit 8 can be coupled between the host HAP and the display panel PL. The driving circuit 8 can include a receiving unit 80, a processing unit 82, a memory 84 and an output unit 86. Wherein, the receiving unit 80 is coupled to the host HAP and the processing unit 82 respectively; the processing unit 82 is coupled to the receiving unit 80, the memory 84 and the output unit 86; the memory 84 is coupled to the processing unit 82; the output unit 86 is coupled to the processing unit 82 and the display panel PL respectively. The display panel PL can include a gate driver GD, such as a gate on array (GOA) circuit, but not limited to this.

In this embodiment, the receiving unit 80 in the driving circuit 8 is used to receive the image data DAT from outside, wherein the image data DAT can include N frames of image, and N is a positive integer. In fact, the image data DAT received by the receiving unit 80 in the driving circuit 8 can be generated by the host HAP after the host HAP processes the original image data DAT0, but not limited to this.

The processing unit 82 in the driving circuit 8 is used to write the image data DAT received by the receiving unit 80 into the memory 84 and read the upside down image data DAT′ from the memory 84, and then the upside down image data DAT′ can be outputted to the display panel PL through the output unit 86. In fact, the image data DAT written into the memory 84 by the processing unit 82 and the image data DAT′ read from the memory 84 by the processing unit 82 will be upside down each other.

The gate driver GD on the display panel PL will perform forward scanning S on the gate switches G1˜GN of each pixel on the display panel PL in order along vertical direction, so that the upside down image data DAT′ transmitted by the driving circuit 8 can be line-by-line stored in each row of pixels on the display panel PL for the upside down display panel PL to display the upside down image data DAT′.

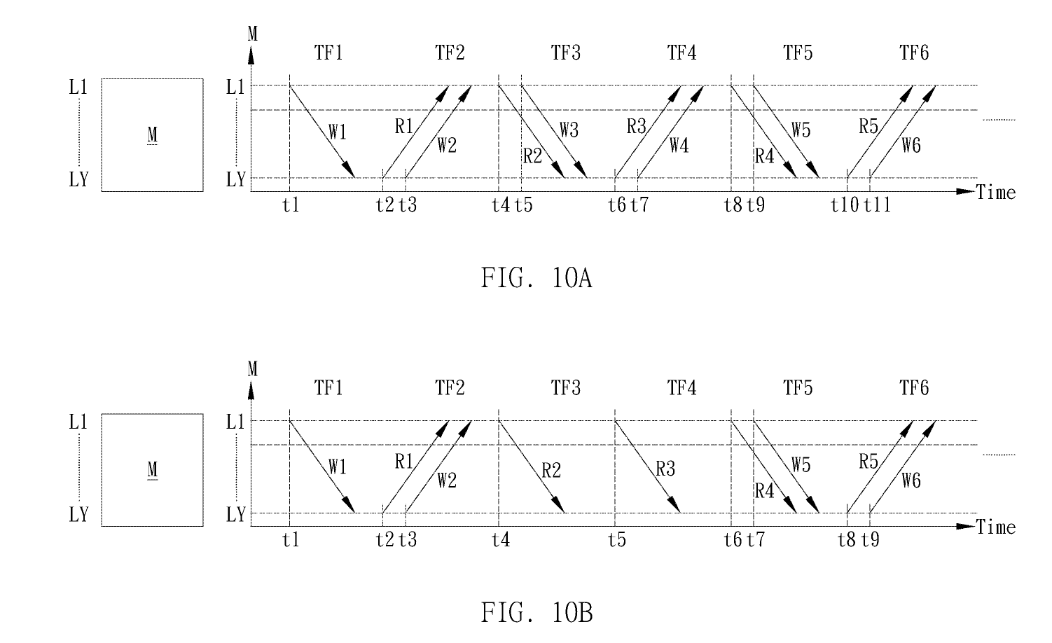

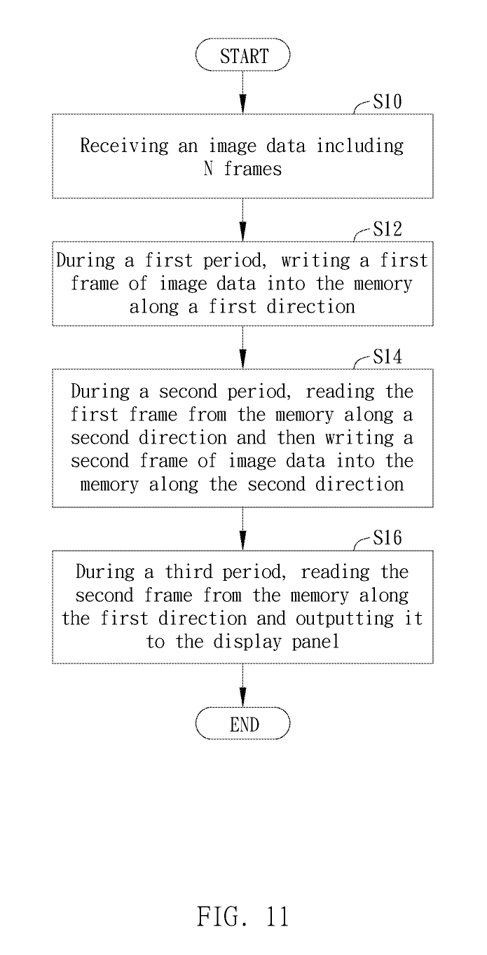

Then, please refer to FIG. 9A˜FIG. 9B and FIG. 10A˜FIG. 10B. FIG. 9A and FIG. 9B illustrate schematic diagrams that the writing direction of writing the current frame of data is the same with the reading direction of reading the previous frame of data during the same frame period in the invention. FIG. 10A and FIG. 10B illustrate timing diagrams that the writing direction of writing the current frame of data is the same with the reading direction of reading the previous frame of data during the same frame period in the invention to avoid the tearing effect.

As shown in FIG. 9A and FIG. 10A, during the first period of time (the first frame period) TF1, the processing unit 82 performs a first writing action W1 at the time t1 to write the first frame of image f1 of the image data DAT into the memory M along a first direction (from top to bottom and from the first row of memory units L1 to the Y-th row of memory units LY). During the second period of time (the second frame period) TF2, the processing unit 82 performs a first reading action R1 at the time t2 to read the upside down first frame of image f1′ from the memory M along a second direction (from bottom to top and from the Y-th row of memory units LY to the first row of memory units L1) and then the processing unit 82 performs a second writing action W2 at the time t3 to write the second frame of image f2 of the image data DAT into the memory M along the second direction (from bottom to top and from the Y-th row of memory units LY to the first row of memory units L1).

It should be noticed that the second period of time (the second frame period) TF2 should be later than the first period of time (the first frame period) TF1 and the second direction (from bottom to top and from the Y-th row of memory units LY to the first row of memory units L1) should be opposite to the first direction (from top to bottom and from the first row of memory units L1 to the Y-th row of memory units LY), so that the first frame of image f1′ read from the memory M by the processing unit 82 and the first frame of image f1 written into the memory M by the processing unit 82 will be upside down each other.

In addition, during the second period of time (the second frame period) TF2, the time t3 that the processing unit 82 performs the second writing action W2 should be later than the time t2 that the processing unit 82 performs the first reading action R1 and the writing direction that the processing unit 82 performs the second writing action W2 should be the same with the reading direction that the processing unit 82 performs first reading action R1 (both are the second direction). By doing so, when the second frame of image f2 is written into the memory M, the second frame of image f2 will not overwrite the first frame of image f1 which is not read yet in the memory M; therefore, the invention can effectively avoid the tearing effect occurred in the prior art.

Similarly, during the third period of time (the third frame period) TF3, the processing unit 82 performs a second reading action R2 at the time t4 to read the upside down second frame of image f2′ from the memory M along the first direction (from top to bottom and from the first row of memory units L1 to the Y-th row of memory units LY) and then the processing unit 82 performs a third writing action W3 at the time t5 to write the third frame of image f3 of the image data DAT into the memory M along the first direction (from top to bottom and from the first row of memory units L1 to the Y-th row of memory units LY).

It should be noticed that the third period of time (the third frame period) TF3 should be later than the second period of time (the second frame period) TF2 and the first direction (from top to bottom) should be opposite to the second direction (from bottom to top), so that the second frame of image f2′ read from the memory M by the processing unit 82 and the second frame of image f2 written into the memory M by the processing unit 82 will be upside down each other.

In addition, during the third period of time (the third frame period) TF3, the time t5 that the processing unit 82 performs the third writing action W3 should be later than the time t4 that the processing unit 82 performs the second reading action R2 and the writing direction that the processing unit 82 performs the third writing action W3 should be the same with the reading direction that the processing unit 82 performs second reading action R2 (both are the first direction). By doing so, when the third frame of image f3 is written into the memory M, the third frame of image f3 will not overwrite the second frame of image f2 which is not read yet in the memory M; therefore, the invention can effectively avoid the tearing effect occurred in the prior art.

As to the conditions of the following fourth period of time (the fourth frame period) TF4, fifth period of time (the fifth frame period) TF5, . . . can be deduced by analogy, which will not be repeated here.

In another embodiment, as shown in FIG. 9B, during the first period of time (the first frame period) TF1, the processing unit 82 performs a first writing action W1 to write the first frame of image f1 of the image data DAT into the memory M along a second direction (from bottom to top). During the second period of time (the second frame period) TF2, the processing unit 82 performs a first reading action R1 to read the upside down first frame of image f1′ from the memory M along a first direction (from top to bottom) and then the processing unit 82 performs a second writing action W2 to write the second frame of image f2 of the image data DAT into the memory M along the first direction (from top to bottom). During the third period of time (the third frame period) TF3, the processing unit 82 performs a second reading action R2 to read the upside down second frame of image f2′ from the memory M along the second direction (from bottom to top) and then the processing unit 82 performs a third writing action W3 to write the third frame of image f3 of the image data DAT into the memory M along the second direction (from bottom to top). As to the conditions of the following fourth period of time (the fourth frame period) TF4, fifth period of time (the fifth frame period) TF5, . . . can be deduced by analogy, which will not be repeated here.

In another embodiment, as shown in FIG. 10B, during the first period of time (the first frame period) TF1, the processing unit 82 performs a first writing action W1 at the time t1 to write the first frame of image into the memory M along a first direction (from top to bottom). During the second period of time (the second frame period) TF2, the processing unit 82 performs a first reading action R1 at the time t2 to read the upside down first frame of image from the memory M along a second direction (from bottom to top) and then the processing unit 82 performs a second writing action W2 at the time t3 to write the second frame of image into the memory M along the second direction (from bottom to top).

During the third period of time (the third frame period) TF3, the processing unit 82 performs a second reading action R2 at the time t4 to read the second frame of image from the memory M along the first direction (from top to bottom), but there is no third writing action W3 occurred in the third period of time (the third frame period) TF3. It means that the image data stored in the memory M is not undated.

During the fourth period of time (the fourth frame period) TF4, the processing unit 82 performs a third reading action R3 at the time t5 to read the third frame of image from the memory M along the first direction (from top to bottom) which is the same with the first direction (from top to bottom) of the second reading action R2.

During the fifth period of time (the fifth frame period) TF5, the processing unit 82 performs a fourth reading action R4 at the time t6 to read the fourth frame of image from the memory M along the first direction (from top to bottom) and then the processing unit 82 performs a fifth writing action W5 at the time t7 to write the fifth frame of image into the memory M along the first direction (from top to bottom).

During the sixth period of time (the sixth frame period) TF6, the processing unit 82 performs a fifth reading action R5 at the time t8 to read the fifth frame of image from the memory M along the second direction (from bottom to top) and then the processing unit 82 performs sixth writing action W6 at the time t9 to write the sixth frame of image into the memory M along the second direction (from bottom to top), and so on, which will not be repeated here.

Another embodiment of the invention is a driving circuit operating method. In this embodiment, the driving circuit operating method is used for operating a driving circuit coupled to a display panel. The driving circuit includes a memory. In practical applications, the display panel can be an OLED display panel; the memory can be a static random access memory (SRAM), but not limited to this.

Please refer to FIG. 11. FIG. 11 illustrates a flowchart of the driving circuit operating method in this embodiment. As shown in FIG. 11, the driving circuit operating method includes following steps.

Step S10: The driving circuit receives an image data including N frames, wherein N is a positive integer. In fact, the image data received by the driving circuit can be generated by the host after the host processes the original image data, but not limited to this.

Step S12: During a first period (a first frame period), the driving circuit writes a first frame of the image data into the memory along a first direction.

Step S14: During a second period (a second frame period), the driving circuit reads the first frame from the memory along a second direction and outputs the first frame to the display panel and then writes a second frame of the image data into the memory along the second direction.

It should be noticed that the second period (the second frame period) should be later then the first period (the first frame period) and the second direction should be opposite to the first direction (e.g., the first direction and the second direction are the direction from top to bottom and the direction from bottom to top respectively), so that the first frame of image read in Step S14 and the first frame of image written in Step S12 will be upside down each other. That is to say, the time that the driving circuit reads the first frame of image from the memory should be one frame period later than the time that the driving circuit writes the first frame of image into the memory and the direction that the driving circuit reads the first frame of image from the memory should be opposite to the direction that the driving circuit writes the first frame of image into the memory.

In addition, in Step S14, during the second period (the second frame period), after the driving circuit reads the first frame of image from the memory, then the driving circuit starts to write the second frame of image into the memory and the writing direction that the driving circuit writes the second frame of image into the memory should be the same with the reading direction that the driving circuit reads the first frame of image from the memory. That is to say, the time that the driving circuit writes the second frame of image into the memory should be later than the time that the driving circuit reads the first frame of image from the memory and the writing direction and the reading direction should be the same (e.g., the second direction). Therefore, when the second frame of image is written into the memory, the second frame of image will not overwrite the first frame of image not read yet in the memory to avoid the tearing effect.

Step S16: During a third period (a third frame period), the driving circuit reads the second frame of image from the memory along the first direction and then outputs it to the display panel, wherein the third period is later than the second period. That is to say, the time that the driving circuit reads the second frame of image from the memory should be one frame period later than the time that the driving circuit writes the second frame of image into the memory and the direction that the driving circuit reads the second frame of image from the memory should be opposite to the direction that the driving circuit writes the second frame of image into the memory.

In practical applications, if there is no new image written into the memory during the third period (the third frame period), then during the fourth period (the fourth frame period), the driving circuit will read the second frame of image from the memory along the first direction and output it to the display panel, wherein the fourth period should be later than the third period. That is to say, since the image stored in the memory is not updated during certain frame period, namely no new image is written into the memory, then during the next frame period, the driving circuit will read the image stored in the memory along the same reading direction and then output it to the display panel.

On the other hand, if the image stored in the memory is updated during the third period (the third frame period), after the driving circuit reads the second frame of image along the first direction, the driving circuit will write the third frame of image into the memory along the first direction. That is to say, the time that the driving circuit writes the third frame of image should be later than the time that the driving circuit reads the second frame of image from the memory and the writing direction should be the same with the reading direction (e.g., the first direction). Therefore, when the third frame of image is written into the memory, the third frame of image will not overwrite the second frame of image not read yet in the memory to avoid the tearing effect.

Next, during the fourth period (the fourth frame period), the driving circuit will read the third frame of image from the memory along the second direction and output it to the display panel, wherein the fourth period should be later than the third period. That is to say, the time that the driving circuit reads the third frame of image from the memory should be one frame period later than the time that the driving circuit writes the third frame of image into the memory and the direction that driving circuit reads the third frame of image from the memory should be opposite to the direction that the driving circuit writes the third frame of image into the memory, and so on, which will not be repeated here.

Compared to the prior art, the driving circuit and operating method thereof in the invention use a new memory writing and reading method to make the image data upside down cooperated with the upside down display panel and also effectively avoid the tearing effect caused by the conventional driving circuit performing V-flip process on the dynamic picture. Therefore, the driving circuit and operating method thereof in the invention can perform V-flip process on both the dynamic picture and the static picture without using the host and the gate driver (e.g., the GOA circuit) on the display panel to perform V-flip process on the image data, so that the scope of its use and practicality can be largely increased.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A driving circuit operating method for operating a driving circuit coupled to a display panel, the driving circuit comprising a memory, the driving circuit operating method comprising steps of:
(a) the driving circuit receiving an image data comprising N frames, wherein N is a positive integer;
(b) during a first period, writing a first frame of the image data into the memory along a first direction; and
(c) during a second period, reading the first frame from the memory along a second direction and outputting the first frame to the display panel and then writing a second frame of the image data into the memory along the second direction;
wherein, since the second period is later then the first period and the second direction is opposite to the first direction, the first frame read from the memory in step (c) and the first frame written into the memory in step (b) are upside down each other.

2. The driving circuit operating method of claim 1, wherein the display panel is an organic light-emitting diode (OLED) display panel.

3. The driving circuit operating method of claim 1, wherein the first direction and the second direction are a direction from top to bottom and a direction from bottom to top respectively.

4. The driving circuit operating method of claim 1, wherein during the second period, a time of writing the second frame of the image data into the memory is later than a time of reading the first frame from the memory, and a direction of writing the second frame of the image data into the memory and a direction of reading the first frame from the memory are both the second direction, so that when the second frame of the image data is written into the memory, the second frame of the image data does not overwrite the first frame of the image data which is not yet read to avoid a tearing effect.

5. The driving circuit operating method of claim 1, further comprising a step of:
during a third period, reading the second frame of the image data from the memory along the first direction and outputting the second frame of the image data to the display panel, wherein the third period is later than the second period.

6. The driving circuit operating method of claim 5, wherein if no image is written into the memory during the third period, then the driving circuit operating method further comprises a step of:
during a fourth period, reading the second frame of the image data from the memory along the first direction and outputting the second frame of the image data to the display panel, wherein the fourth period is later than the third period.

7. The driving circuit operating method of claim 5, further comprising a step of:
during the third period, after the second frame of the image data is read, writing a third frame of the image data into the memory along the first direction; and
during a fourth period, reading the third frame of the image data from the memory along the second direction and outputting the third frame of the image data to the display panel, wherein the fourth period is later than the third period.

8. A driving circuit, coupled to a display panel, comprising:
a receiving unit, for receiving an image data comprising N frames, wherein N is a positive integer;
a memory;
a processing unit, coupled to the receiving unit and the memory respectively, during a first period, the processing unit writing a first frame of the image data into the memory along a first direction; during a second period, the processing unit reading the first frame from the memory along a second direction and then writing a second frame of the image data into the memory along the second direction; and
an output unit, coupled to the processing unit and the display panel respectively, for outputting the first frame to the display panel;
wherein, since the second period is later then the first period and the second direction is opposite to the first direction, the first frame read from the memory by the processing unit and the first frame written into the memory by the processing unit are upside down each other.

9. The driving circuit of claim 8, wherein the display panel is an organic light-emitting diode (OLED) display panel.

10. The driving circuit of claim 8, wherein the first direction and the second direction are a direction from top to bottom and a direction from bottom to top respectively.

11. The driving circuit of claim 8, wherein during a second period, a time of the processing unit writing the second frame of the image data into the memory is later than a time of the processing unit reading the first frame from the memory, and a direction of the processing unit writing the second frame of the image data into the memory and a direction of the processing unit reading the first frame from the memory are both the second direction, so that when the second frame of the image data is written into the memory by the processing unit, the second frame of the image data does not overwrite the first frame of the image data which is not yet read by the processing unit to avoid a tearing effect.

12. The driving circuit of claim 8, wherein during a third period, the processing unit reads the second frame of the image data from the memory along the first direction and outputs the second frame of the image data to the display panel, and the third period is later than the second period.

13. The driving circuit of claim 12, wherein if no image is written into the memory by the processing unit during the third period, then during a fourth period, the processing unit reads the second frame of the image data from the memory along the first direction and outputs the second frame of the image data to the display panel, and the fourth period is later than the third period.

14. The driving circuit of claim 12, wherein during the third period, after the processing unit reads the second frame of the image data, the processing unit writes a third frame of the image data into the memory along the first direction; during a fourth period, the processing unit reads the third frame of the image data from the memory along the second direction and outputs the third frame of the image data to the display panel, and the fourth period is later than the third period.
